(19) United States
(12) Patent Application Publication
(10) Pub. No.: US 2019/0202578 A1
(43) Pub. Date: Jul. 4, 2019

(54) POSITIONING AND LOCKING SYSTEM AND METHOD FOR UNMANNED VEHICLES

(71) Applicant: AIROBOTICS LTD., Petah Tikva (IL)

(72) Inventors: Yuval FOX, Hod Hasharon (IL); Meir KLINER, Ramat Gan (IL); Ran KRAUSS, Beer Sheva (IL)

(73) Assignee: Airobotics Ltd., Petah Tikva (IL)

(21) Appl. No.: 16/310,591

(22) PCT Filed: Jun. 18, 2017
(86) PCT No.: PCT/IL2017/050673

§ 371 Date: Dec. 17, 2018

(30) Foreign Application Priority Data
Jun. 20, 2016 (IL) 246358

(51) Int. Cl. B64F 1/22; B64C 39/02

(52) U.S. Cl. CPC B64F 1/22; B64C 2201/12; B64C 2201/145; B64C 39/024

(57) ABSTRACT

A centering system for positioning an Unmanned Autonomous Vehicle (UAV) is provided with two or more supporting extremities rigidly connected thereto, comprising a pair of displaceable positioning elements provided with surfaces sloped relative to each other, which create trapping areas such that when said positioning elements are caused to move one relative to the other, said two or more supporting extremities are caused to be trapped in said trapping areas.

### FIELD OF THE INVENTION

The present invention relates to an automated positioning and securing system and method for unmanned vehicles, which is useful for a variety of land and airborne vehicles, such as motorcars and drones.

### BACKGROUND OF THE INVENTION

Unmanned autonomous vehicles (UAVs) are becoming increasingly useful in performing a variety of tasks previously performed by human operators. For the UAVs to attain their maximal efficiency they need to be serviced by refilling and/or replacing a variety of elements, such as batteries and payloads. These operations must also be performed in an automated manner and without human intervention, in order for the operation to be of the highest efficiency. However, because of the difficulty in obtaining an exact and consistent positioning of the UAV when reaching its home platform, a great burden is placed on the servicing apparatus, which results in increased costs and complication of the system, and in some cases human intervention is unavoidable. It would therefore be highly desirable to provide a system and a method of operating, which leads to an exact positioning of the UAV each time, with minimal and acceptable tolerance, which permits to employ simple and less expensive apparatus for servicing the UAV.

It is an object of the invention to provide such a method and system, which is simple, accurate and which provides consistent results.

It is another object of the invention to provide such a method, which does not require complicated and expensive apparatus to accomplish a high level of precision in positioning the UAV on its servicing station.

Other objects and advantages of the invention will become apparent as the description proceeds.

### SUMMARY OF THE INVENTION

The centering system for positioning an Unmanned Autonomous Vehicle (UAV) provided with two or more supporting extremities rigidly connected thereto, comprises a pair of displaceable positioning elements provided with surfaces sloped relative to each other, which create trapping areas, such that when said positioning elements are caused to move one relative to the other, said two or more supporting extremities are caused to be trapped in said trapping areas. In one embodiment of the invention the positioning elements are linearly displaceable one toward the other.

According to one embodiment of the invention the trapping area is located at the apex of a shape formed by two slopes located on two ideal intersecting lines. In one embodiment of the invention the slopes can be non-linear in shape, e.g., elliptical or semi-circular. In another embodiment of the invention the two slopes are located on a monolithic structure, and in yet a further embodiment of the invention the two slopes are located on independently displaceable structures.

According to one embodiment of the invention the centering system is further provided with a fine-positioning system. In one embodiment the fine-positioning system comprises at least two rod-like engaging elements. In another embodiment the centering system of the invention is further provided with a locking system to prevent the UAV from moving during servicing. In still another embodiment of the invention the fine-positioning system and the locking system of the centering system can be combined into a single unit. In one embodiment of the invention the at least two rods are suitable to be seated with two matching recesses provided in the UAV, the axis of which may be perpendicular or parallel to the plane of the landing platform, or may be oriented at an angle with it.

In one embodiment of the invention the centering system is conveniently designed with rods provided below the servicing platform, which are able to protrude above it and to engage the UAV. While the centering system of the invention can be conveniently used for a variety of UAVs, it is particularly advantageous when the UAV is a drone and therefore a drone has been used to illustrate it.

In another aspect the invention is directed to a method for positioning an Unmanned Autonomous Vehicle (UAV) provided with two or more supporting extremities rigidly connected thereto, comprising the steps of:
a) providing a pair of linearly displaceable positioning elements provided with sloped surfaces culminating in trapping areas; and
b) displacing said positioning elements one toward the other thereby causing said two or more supporting extremities to be trapped in said trapping areas.

As explained above with reference to particular embodiments of the invention, said trapping area is located at the apex of a shape formed by two slopes located on two ideal intersecting lines and can be of any suitable shape, such as linear, elliptical or semi-circular.

The invention further encompasses a method for positioning an Unmanned Autonomous Vehicle (UAV), further comprising providing a fine-positioning system to achieve more precise positioning of the UAV.

Also covered by the invention is the use of a locking system to prevent the UAV from moving during servicing.

In one embodiment of the invention the method comprises providing at least two rods suitable to be seated with two matching recesses provided in the UAV and causing said rods to engage said matching recesses by causing a relative motion of the drone and the rods such as to bring them into contact with one another.

### BRIEF DESCRIPTION OF THE DRAWINGS

In the drawings:

FIG. 1 is a schematic illustration of a landing platform according to one embodiment of the invention;

FIG. 2 illustrated a centering system according to one embodiment of the invention;

FIG. 3(a) shows the centering system before the beginning of its operation;

FIG. 3(b) shows the centering system in an intermediate position;

FIG. 3(c) shows the centering system in its final position;

FIG. 4 shows positioning and locking recesses at the bottom of a drone's arms, according to one embodiment of the invention;

FIG. 5 shows a fine-positioning and locking mechanism according to one embodiment of the invention; and

FIG. 6 shows a drone in its locked position, with the centering system removed.

FIG. 7 shows an engaging element attached to an elongated displacement apparatus.

### DETAILED DESCRIPTION OF THE INVENTION

The invention will be described with reference to a specific UAV, i.e., a drone, it being understood that it is not limited to any particular type of UAV and that it can be employed with a variety of UAVs and setups.

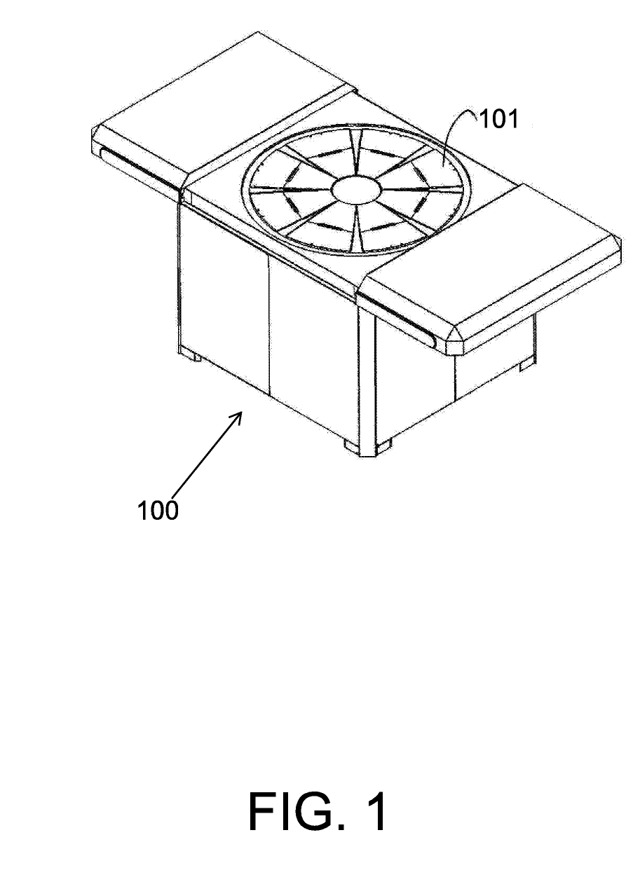

Servicing stations can be of a variety of types and one type, suitable to service a drone, is the box-like platform 100, shown in FIG. 1. The box contains a variety of apparatus, depending on the operations that have to be performed at that specific location, such as robotic apparatus for payload and battery swap. Landing of the drone takes place on the box top 101, which is provided with movable parts that can be used to lower the drone into the box, to lift apparatus needed to perform operations at the top level, and for any other purpose. As will be apparent to the skilled person, many different mechanical setups can be devised for the movable top portion of the box and the setup shown and described herein is just one of many possible examples, given for the purpose of illustration.

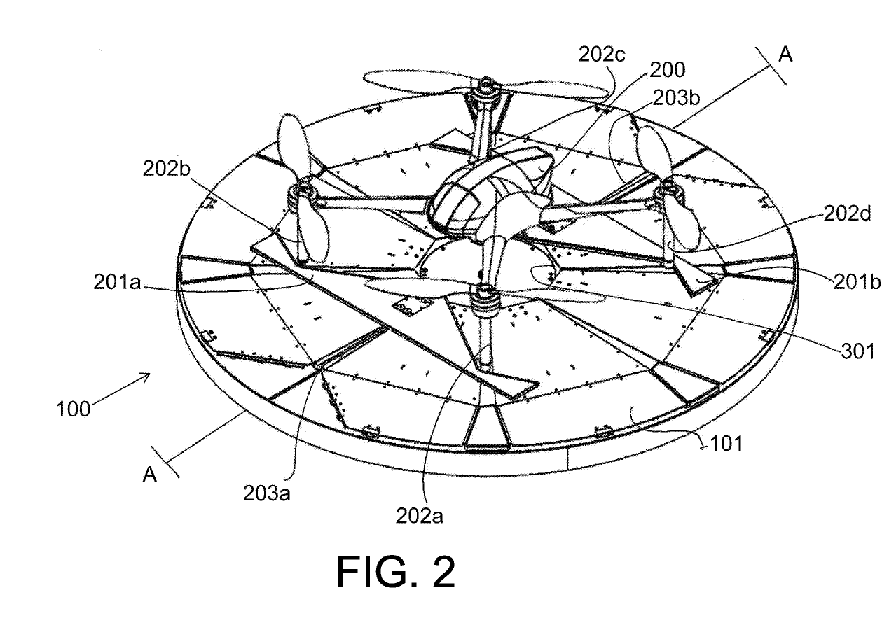

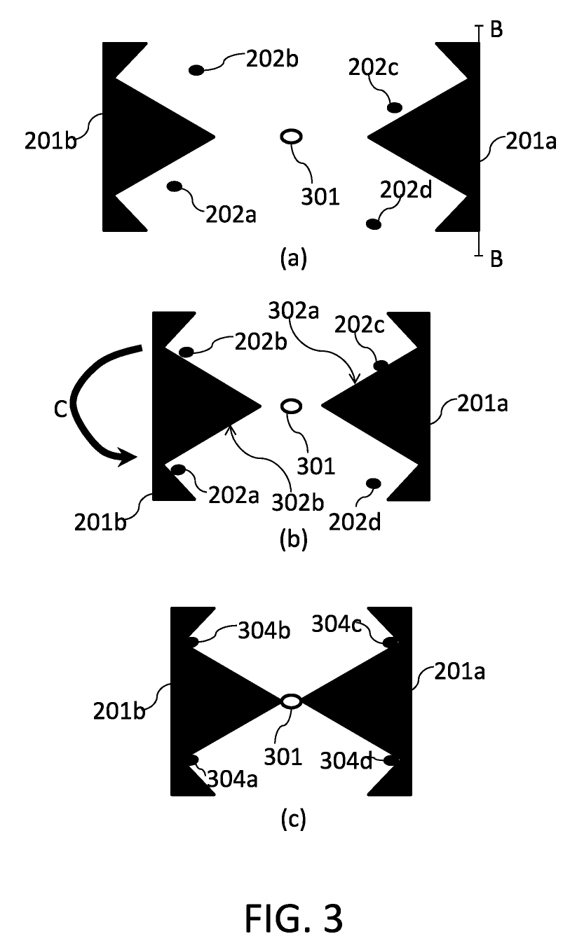

The unmanned landing of the drone onto the landing platform (the top of the box) cannot be done with absolute precision by its very nature, due to external disturbances such as, for example, wind, ground effects, etc. so that typically, after the drone has landed on the platform, it is relatively close to the center but is not precisely centered and is not aligned with the box. This situation is illustrated in FIG. 2, which shows a drone, 200, that has landed on a platform 101 and right after landing was off-center. In order to center it with respect to the landing platform there is provided a centering system comprised of two engaging elements, 201a and 201b, which are adapted to engage the legs of the drone, indicated by numerals 202a through 202d. The operation of a centering system according to a particular embodiment of the invention is schematically illustrated in FIG. 3. FIG. 3(a) is a schematic cross-sectional top view taken along the AA plane of FIG. 2. In FIG. 3(a) the drone has just landed and is askew with respect to the BB plane, which represents its desired orientation. Moreover, legs 202a-202d are positioned toward the left side and not symmetric with respect to the center of platform 101 (FIG. 2), which is represented by central opening 301.

In order to impart the correct orientation to the drone, engaging elements 201a and 201b are linearly displaced one toward the other. As will be apparent to a skilled person, the two engaging elements 201a and 201b can be replaced by any number of engaging elements of a variety of shapes, which can be caused to move in non-linear motion (as opposed to the schematic example of FIG. 3), if their shape demands it. Suitable displacement mechanisms for elements 201a and 201b (or for other shapes of said elements) can be easily devised by the skilled person and, therefore, are not described herein in detail, for the sake of brevity. In the example of FIG. 2 elements 201a and 201b are rigidly connected via a rod passing through a slit of platform 101 (indicated by 203a and 203b in the figure) to a couple of linear displacement motors, which cause each of said elements to move by a predetermined length toward the center of the platform. As said, many alternative arrangements can be provided and the specific arrangement used in each case will be dictated by engineering and space considerations.

FIG. 3(b) show an intermediate position in the centering process, where three of the legs, 202a, 202b and 202d have come into contact with the inner surfaces 302a and 302b of engaging elements 201a and 201b, which leg 202c is still inside the empty space between the engaging elements. A further displacement of the engaging elements 201a and 201b will create two distinct movements: the drone will rotate in the direction of arrow C of FIG. 3(b), until leg 202c also touches inner surface 302, and then the whole drone will be moved to the right until the four legs seat themselves into apices 304a-304d of engaging elements 201a and 201b. When this happens, as schematically shown in FIG. 3(c), the drone is correctly oriented and each time it lands it will be oriented in the same way. It will be appreciated that this device is very efficient, as it is capable of correcting skewed position up to 90° of desired heading.

In a preferred embodiment of the invention each of apices 304a-304d is provided with a contact, such as a micro switch, that signals the system that all legs 202a-202d are correctly seated therein. In order to lock the drone in place, according to one embodiment of the invention the engaging elements can be kept in their final position, bearing upon the legs during the servicing operations, to prevent the drone from moving.

The procedure described above positions the drone (or other UAV) in the correct position, but with a tolerance given by the precision that can be achieved with rough mechanical means such as the engaging elements 201a and b, also in view of the fact that the drone's legs may become deformed with time and lose their precise positioned relationship with the body of the drone. Two additional improvements can be provided, which are advantageous in many cases. Therefore, according to a preferred embodiment of the invention a fine-positioning system is also provided. According to another preferred embodiment of the invention, a locking system is added, to ensure that once the drone has been correctly positioned, it will not inadvertently shift to a less optimal position, which may happen during service operations, for instance, due to vibrations caused by the operation of apparatus located in the landing platform, or because of servicing operations, such as the exchange of batteries or other payload. According to yet another preferred embodiment of the invention, which will be illustrated hereinafter, the fine-positioning and the fastening systems are combined into one.

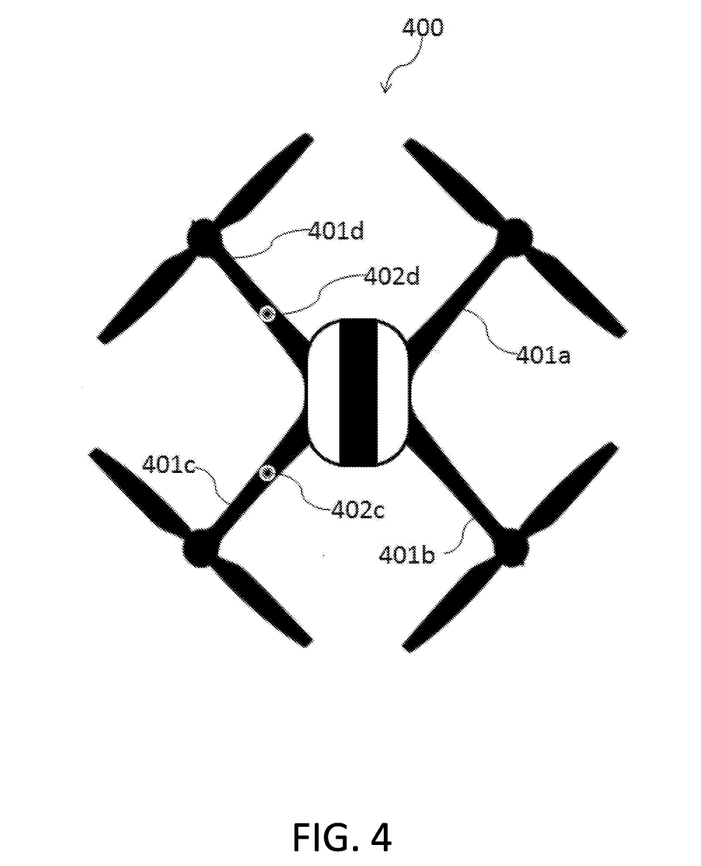

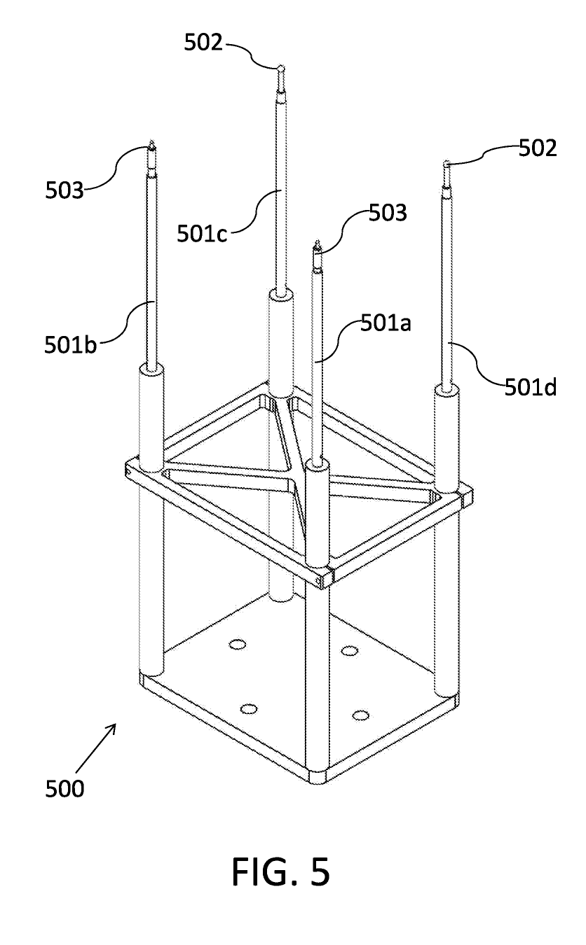

Referring now to FIG. 4, the bottom 400 of an illustrative drone is shown, with its four legs, 401a-401d (which are truncated in the figure for convenience). A recess is provided in each of arms 401b and 401d (although if desired, recesses can be provided also in the remaining two arms), the purpose of which will become evident from the description to follow. Referring now to FIG. 5, a fine-positioning and locking apparatus 500 is seen, which is provided with four rods, indicated by numerals 501a-501d. Rods 501c and 501d are provided, in this specific illustrative example of an embodiment of the invention, with spherical ends 502, adapted to fit precisely into recesses 402c and 402d, respectively (FIG. 4). Rods 501a and 501c, on the other hand, according to this particular embodiment are provided with rubber ends 503, which come into contact with arms 401a and 401c and serve to balance. This arrangement yields tight positional tolerance and provides rigidity to allow the servicing apparatus, such as a robotic arm used to swap batteries or to handle payload, to engage with the drone effectively. When a relative movement of the rods and the platform takes place, either due to a lowering of the platform or to a lifting of apparatus 500, the rods come into contact with the drone's arms. Of course, a different number of rods can be provided, with different tips, as befitting the construction of the drone. For instance, the tip of the rods can be recessed and the drone's arms may have protrusions that fit into such recesses, instead of the opposite male-female arrangement. Moreover, different arrangements, such as fast connectors, can be provided to engage the rods with the drone.

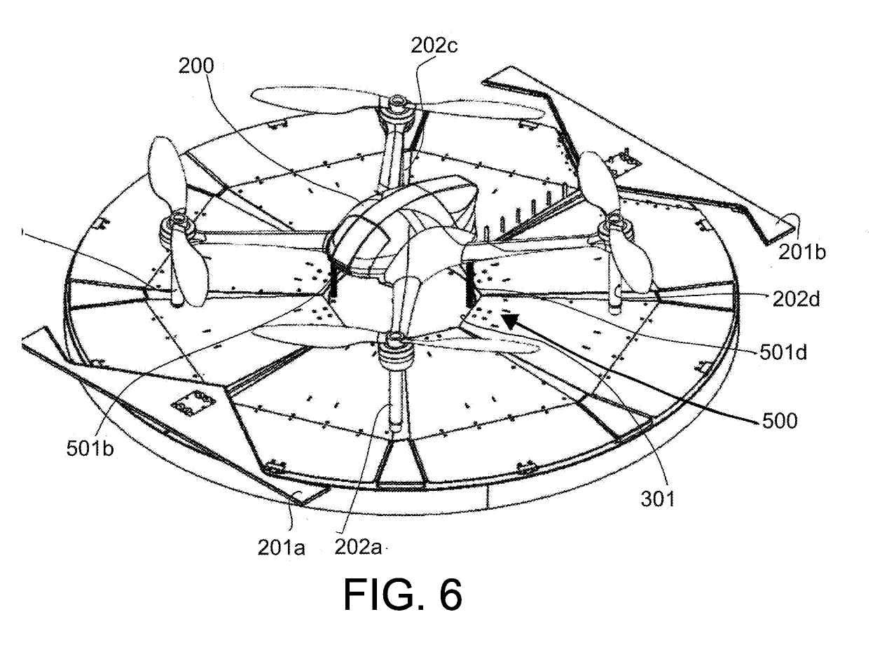

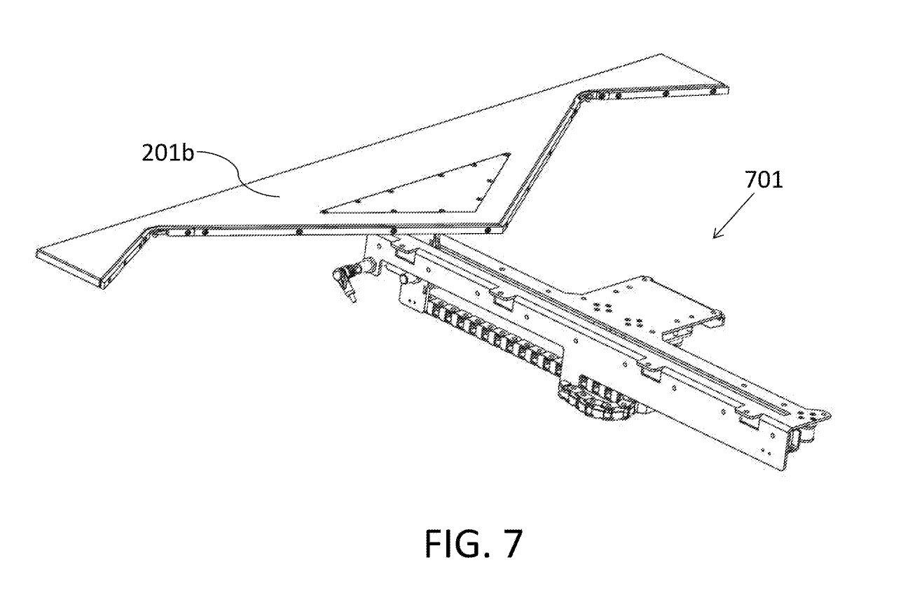

The operation of these systems can be further appreciated from FIG. 6, which shows the engagement of fine-positioning and locking apparatus 500 with drone 200. As can be appreciated from the figure, when platform 101 is lowered into box 100, fine-positioning and locking apparatus 500, which in this illustrative embodiment is positioned below it, at the center 301 of the landing platform, emerges through it and engages the drone, as described with reference to FIGS. 4 and 5. In FIG. 6 only rods 501b and 501d are seen, as rods 501a and 501c are hidden by legs 202a and 202c. At this stage, it is possible to release the centering system by displacing engaging elements 201a and 201b away from the legs of the drone. An engaging element (e.g. 201b of FIG. 2) is schematically illustrated in FIG. 7 attached to an elongated displacement apparatus 701, which can be of any suitable type and can contain, e.g., a chain or any other actuating element.

All the above description of a preferred embodiment has been provided for the purpose of illustration and is not meant to limit it in any way. Many variations can be made to the various systems and elements of the invention, as well as to the way in which they are operated. For instance, different shapes of the engaging elements could be devices, different shapes and numbers of rods could be used, and other drones, landing platforms and sets and order of operations could be employed, all without exceeding the scope of the claims.

1. A centering system for positioning an Unmanned Autonomous Vehicle (UAV) provided with two or more supporting extremities rigidly connected thereto, comprising a pair of displaceable positioning elements provided with surfaces sloped relative to each other, which create trapping areas such that when said positioning elements are caused to move one relative to the other, said two or more supporting extremities are caused to be trapped in said trapping areas.

2. A centering system according to claim 1, wherein said trapping area is located at the apex of a shape formed by two slopes located on two ideal intersecting lines.

3. A centering system according to claim 2, wherein the two slopes are located on a monolithic structure.

4. A centering system according to claim 2, wherein the two slopes are located on independently displaceable structures.

5. A centering system according to claim 2, wherein the slopes can be non-linear in shape.

6. A centering system according to claim 5, wherein the slopes are elliptical or semi-circular.

7. A centering system according to claim 1, further provided with a fine-positioning system.

8. The centering system of claim 7, wherein the fine-positioning system comprises at least two rod-like engaging elements.

9. A centering system according to claim 1, further provided with a locking system to prevent the UAV from moving during servicing.

10. A centering system according to claim 8, which is combined with a locking system.

11. The centering system of claim 8, wherein the at least two rods are suitable to be seated with two matching recesses provided in the UAV.

12. The centering system of claim 11, wherein the rods are provided below the servicing platform and are able to protrude above it and to engage the UAV.

13. The centering system of claim 1, wherein the UAV is a drone.

14. A method for positioning an Unmanned Autonomous Vehicle (UAV) provided with two or more supporting extremities rigidly connected thereto, comprising the steps of:
a) providing a pair of linearly displaceable positioning elements provided with sloped surfaces culminating in trapping areas; and
b) displacing said positioning elements one toward the other thereby causing said two or more supporting extremities to be trapped in said trapping areas.

15. A method according to claim 14, wherein said trapping area is located at the apex of a shape formed by two slopes located on two ideal intersecting lines.

16. A method according to claim 14, further comprising providing a fine-positioning system to achieve more precise positioning of the UAV.

17. A method according to claim 14, further comprising providing a locking system to prevent the UAV from moving during servicing.

18. A method according to claim 16, wherein the fine-positioning system is combined with a locking system.

19. The method of claim 18, which comprises providing at least two rods suitable to be seated with two matching recesses provided in the UAV and causing said rods to engage said matching recesses.

20. The method of claim 19, comprising positioning the rods below the servicing platform and lowering the platform such that said rods protrude above it and to engage the UAV.

21. The method of claim 14, wherein the UAV is a drone.

22. The method of claim 21, wherein the drone is held in position during servicing by maintaining the displaceable positioning elements in their engaged, closest position which prevents the drone from moving.
